(19) United States
(12) Patent Application Publication
(10) Pub. No.: US 2020/0014426 A1
(43) Pub. Date: Jan. 9, 2020

(54) ANTENNA DEVICE, ANTENNA COIL, AND ELECTRONIC APPARATUS

(71) Applicant: Murata Manufacturing Co., Ltd., Kyoto-fu (JP)

(72) Inventor: Masayoshi YAMAMOTO, Nagaokakyo-shi (JP)

(73) Assignee: Murata Manufacturing Co., Ltd., Kyoto-fu (JP)

(21) Appl. No.: 16/577,099

(22) Filed: Sep. 20, 2019

Related U.S. Application Data
(63) Continuation of application No. PCT/JP2018/021923, filed on Jun. 7, 2018.

(30) Foreign Application Priority Data
Jun. 9, 2017 (JP) 2017-114713

(51) Int. Cl. H04B 5/00; H01F 38/14; H01Q 1/24

(52) U.S. Cl. CPC H04B 5/0081; H01F 38/14; H01F 2038/143; H04B 5/0093; H01Q 1/243; H04B 5/0031

(57) ABSTRACT

Antenna characteristics are improved without impairing strength of a conductor. An antenna device includes an antenna coil, a first conductor, and a second conductor. The antenna coil is positioned between the first conductor and the second conductor in a first direction. In a coil conductor of the antenna coil, a first coil conductor portion is closer to a first main surface than to a second main surface of a magnetic body. A second coil conductor portion is closer to the second main surface than to the first main surface of the magnetic body. The second coil conductor portion overlaps with the second conductor in a plan view of the magnetic body, and at least a part of the second coil conductor portion is arranged along an edge end of the second conductor.

This application claims benefit of priority to International Patent Application No. PCT/JP2018/021923, filed Jun. 7, 2018, and to Japanese Patent Application No. 2017-114713, filed Jun. 9, 2017, the entire contents of each are incorporated herein by reference.

### BACKGROUND

### Technical Field

The present disclosure relates to an antenna device, an antenna coil, and an electronic apparatus.

### Background Art

Japanese Unexamined Patent Application Publication No. 2002-341057 discloses a wristwatch having an antenna built therein. The wristwatch disclosed in Japanese Unexamined Patent Application Publication No. 2002-341057 includes a watch case and an antenna. The antenna includes a magnetic core member formed in a ring shape, and a coil wound around the outer periphery of the magnetic core member. The watch case includes an annular frame formed of a metal in a circular ring shape and a rear lid formed of an electrically insulating material in a disc shape, and accommodates the antenna.

Incidentally, as described above, in the case where the annular frame of the watch case is made of the metal having electrical conductivity, when a current flows in the coil constituting the antenna, since an induced current flows in the annular frame, antenna characteristics is deteriorated in some cases. Therefore, in the wristwatch disclosed in Japanese Unexamined Patent Application Publication No. 2002-341057, in order to suppress the induced current from being generated in the annular frame, a slit is formed in the annular frame.

### SUMMARY

However, in the wristwatch (electronic apparatus) disclosed in Japanese Unexamined Patent Application Publication No. 2002-341057, although it is possible to suppress the deterioration in the antenna characteristics caused by the induced current generated in the annular frame (conductor), the strength of the case is lowered in some cases because the slit is formed in the annular frame. That is, since the watch case is required to be increased in strength, it is difficult to form the slit in the annular frame in some cases.

In addition, in the electronic apparatus such as the wristwatch disclosed in Japanese Unexamined Patent Application Publication No. 2002-341057, it is required to further improve the antenna characteristics. In the wristwatch disclosed in Japanese Unexamined Patent Application Publication No. 2002-341057, in order to improve the antenna characteristics, increasing a magnetic flux can be considered by increasing the number of turns of the coil or enlarging the coil and the magnetic core member, but there is a problem in that these lead to enlargement of the wristwatch as a whole.

Accordingly, the present disclosure provides an antenna device, an antenna coil, and an electronic apparatus, capable of improving antenna characteristics without impairing strength of a conductor.

An antenna device according to an aspect of the present disclosure includes an antenna coil, a first conductor, and a second conductor. The antenna coil includes a magnetic body having a first main surface and a second main surface and a coil conductor having a spiral shape. The first conductor is arranged opposing the first main surface of the magnetic body. The second conductor is arranged opposing the second main surface of the magnetic body. When viewed from a direction along the first main surface or the second main surface of the magnetic body, the antenna coil is positioned between the first conductor and the second conductor. The coil conductor includes a first coil conductor portion and a second coil conductor portion. The first coil conductor portion is closer to the first main surface than to the second main surface of the magnetic body. The second coil conductor portion is closer to the second main surface than to the first main surface of the magnetic body. The first coil conductor portion and the second coil conductor portion are positioned at positions not overlapping with each other in a plan view of the magnetic body. The first coil conductor portion overlaps with the first conductor in a plan view of the magnetic body, and at least a part of the first coil conductor portion is arranged along an edge end of the first conductor in a plan view of the magnetic body. The second coil conductor portion overlaps with the second conductor in a plan view of the magnetic body, and at least a part of the second coil conductor portion is arranged along an edge end of the second conductor in a plan view of the magnetic body.

An antenna coil according to an aspect of the present disclosure includes a magnetic body, and a coil conductor. The magnetic body has a first main surface and a second main surface. The coil conductor has a spiral shape. When viewed from a direction along the first main surface or the second main surface of the magnetic body, the magnetic body and the coil conductor are positioned between a first conductor and a second conductor. The coil conductor includes a first coil conductor portion and a second coil conductor portion. The first coil conductor portion is closer to the first main surface than to the second main surface of the magnetic body. The second coil conductor portion is closer to the second main surface than to the first main surface of the magnetic body. The first coil conductor portion and the second coil conductor portion are positioned at positions not overlapping with each other in a plan view of the magnetic body. The first coil conductor portion overlaps with the first conductor in a plan view of the magnetic body, and at least a part of the first coil conductor portion is arranged along an edge end of the first conductor in a plan view of the magnetic body. The second coil conductor portion overlaps with the second conductor in a plan view of the magnetic body, and at least a part of the second coil conductor portion is arranged along an edge end of the second conductor in a plan view of the magnetic body.

An electronic apparatus according to an aspect of the present disclosure includes the antenna device and a signal processing circuit. The signal processing circuit performs signal processing on a signal of the antenna device.

According to the antenna device, the antenna coil, and the electronic apparatus according to the aspects of the present disclosure, antenna characteristics can be improved without impairing strength of the conductors (the first conductor and the second conductor).

### BRIEF DESCRIPTION OF THE DRAWINGS

FIG. 1 is a cross-sectional view of an antenna device according to a first embodiment of the present disclosure;

FIG. 2 is an exploded perspective view of the above-described antenna device;

FIG. 3 is a schematic diagram of an electronic apparatus and an external apparatus according to the first embodiment of the present disclosure;

FIG. 4A is a front view of an antenna coil according to the first embodiment of the present disclosure, FIG. 4B is a front view of a base member, a coil conductor, and a protective layer of the above-described antenna coil, and FIG. 4C is a front view of a magnetic body of the above-described antenna coil;

FIG. 5 is a distribution diagram illustrating magnetic flux distribution during operation of the above-described antenna device;

FIG. 6 is a front view of a magnetic body of an antenna coil according to a modification of the first embodiment of the present disclosure;

FIG. 7 is a cross-sectional view of an antenna device according to a second embodiment of the present disclosure;

FIG. 8 is an exploded perspective view of the above-described antenna device;

FIG. 9 is a cross-sectional view of an antenna device according to a third embodiment of the present disclosure;

FIG. 10A is a perspective view of the above-described antenna device, and FIG. 10B is a front view of the above-described antenna device;

FIG. 11 is an exploded perspective view of the above-described antenna device; and

FIG. 12 is a front view of a coil conductor and a magnetic body in the above-described antenna device.

### DETAILED DESCRIPTION

An “antenna device” described in each embodiment is an antenna device used to perform near field communication using magnetic field coupling. This antenna device is applied to communication such as NFC (Near Field Communication) or the like, for example. That is, the “antenna device” described in each embodiment is used in a wireless transmission system using at least communication or the like by magnetic field coupling. Note that the “antenna device” described in each embodiment also includes a device that substantially performs wireless transmission by an electromagnetic field coupling (magnetic field coupling and electric field coupling) with an antenna device of an external apparatus.

The “antenna device” described in each embodiment is used, for example, in a shortwave band (HF band), and is particularly used at 13.56 MHz or 6.78 MHz, or in a frequency band in the vicinity of these frequencies.

Hereinafter, an antenna device and an electronic apparatus according to each embodiment will be described with reference to the drawings.

### First Embodiment

(1) Overall Configuration of Antenna Device

Hereinafter, an antenna device according to a first embodiment will be described in detail with reference to the drawings.

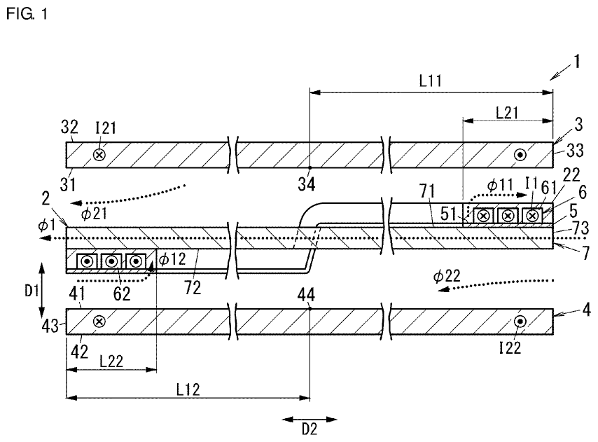

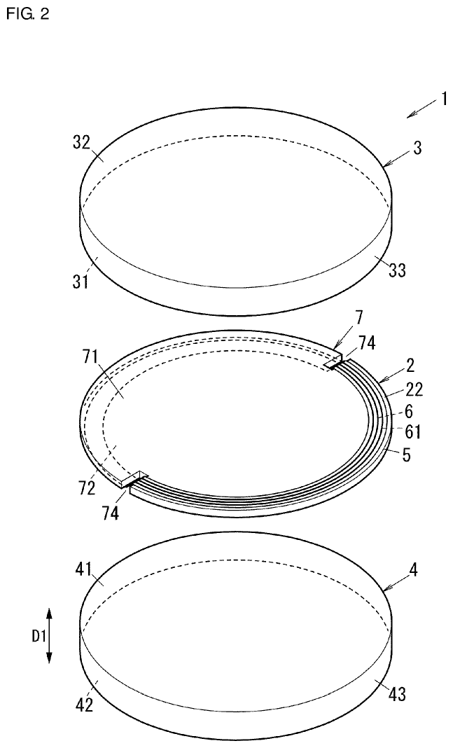

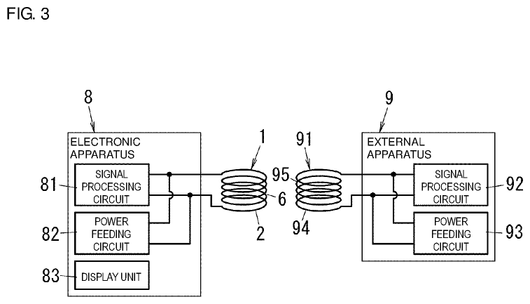

As illustrated in FIG. 1 and FIG. 2, an antenna device 1 according to the first embodiment includes an antenna coil 2, a first conductor 3, and a second conductor 4. As illustrated in FIG. 3, the antenna device 1 is mounted in an electronic apparatus 8 that performs wireless communication with an external apparatus 9 and used, and performs wireless communication with an antenna device 91 of the external apparatus 9. Here, the antenna device 1 is an active tag which does not depend on power feeding from the outside. Note that in FIG. 1, each portion is exaggeratedly illustrated in thickness thereof. The same applies to the other cross-sectional views. Additionally, in FIG. 1, a first direction D1 is an up-down direction, and a second direction D2 is a left-right direction and is orthogonal to the first direction D1.

(2) Electronic Apparatus

Next, the electronic apparatus 8 in which the antenna device 1 is mounted will be described with reference to the drawings.

As illustrated in FIG. 3, the electronic apparatus 8 includes the antenna device 1, a signal processing circuit 81, a power feeding circuit 82, and a display unit 83.

The signal processing circuit 81 is configured to perform signal processing on signals (a transmission signal and a reception signal) of the antenna device 1. The signal processing circuit 81 performs signal processing on the transmission signal transmitted from the antenna device 1 and the reception signal received by the antenna device 1. The power feeding circuit 82 is configured to feed electric power to the antenna device 1 in a case where a signal is transmitted from the antenna device 1 to the external apparatus 9 or the like. The display unit 83 is configured to display prescribed information, and is provided on an opposite side from the antenna coil 2 with respect to the first conductor 3 in the first direction D1 (see FIG. 1). The display unit 83 displays information on communication between the electronic apparatus 8 and the external apparatus 9, such as a result of the signal processing performed by the signal processing circuit 81 or the like. The signal processing circuit 81 and the power feeding circuit 82 may be circuits configured in the same package.

The electronic apparatus 8 is, for example, a wristwatch-type wearable terminal. When the electronic apparatus 8 is a wristwatch, the display unit 83 is configured to display information such as a current time or the like.

The communication between the electronic apparatus 8 and the external apparatus 9 is, for example, communication for the purpose of authentication between the electronic apparatus 8 and the external apparatus 9, or communication for the purpose of transmitting and receiving information between the electronic apparatus 8 and the external apparatus 9.

(3) External Apparatus

Next, the external apparatus 9 to be a communication partner of the electronic apparatus 8 will be described with reference to the drawings.

As illustrated in FIG. 3, the external apparatus 9 includes the antenna device 91, a signal processing circuit 92, and a power feeding circuit 93.

The antenna device 91 includes an antenna coil 94. The antenna coil 94 includes a coil conductor 95. The coil conductor 95 is wound a plurality of times so as to have a circular annular shape, for example.

The external apparatus 9 is, for example, a mobile phone (including a smartphone), a notebook computer, a tablet terminal, a wearable terminal, a PDA (Personal Digital Assistant), a camera, or a game machine.

(4) Constituent Elements of Antenna Device

Next, constituent elements of the antenna device 1 will be described in detail with reference to the drawings.

(4.1) First Conductor

As illustrated in FIG. 1 and FIG. 2, the first conductor 3 is formed of a metal or the like in a disc shape. An axial direction of the first conductor 3 coincides with the first direction D1. The first conductor 3 has a first main surface 31, a second main surface 32, and an outer peripheral surface 33. The first main surface 31 and the second main surface 32 each have a circular shape and are positioned at both ends of the first conductor 3, respectively, in the axial direction (first direction D1). Additionally, the first main surface 31 and the second main surface 32 face each other, and a normal direction of the first main surface 31 and a normal direction of the second main surface 32 substantially coincide with the first direction D1. The outer peripheral surface 33 connects an outer peripheral edge of the first main surface 31 and an outer peripheral edge of the second main surface 32 to each other.

In the first conductor 3, a dimension ratio of a dimension in the second direction D2 to a dimension in the first direction D1 is larger than 1. That is, the first conductor 3 is a planar conductor whose dimension in the radial direction is longer than a dimension in the axial direction.

(4.2) Second Conductor

As illustrated in FIG. 1 and FIG. 2, the second conductor 4 is formed of a metal or the like in a disc shape. An axial direction of the second conductor 4 coincides with the first direction D1. The second conductor 4 has a first main surface 41, a second main surface 42, and an outer peripheral surface 43. The first main surface 41 and the second main surface 42 each have a circular shape and are positioned at both ends of the second conductor 4, respectively, in the axial direction (first direction D1). Additionally, the first main surface 41 and the second main surface 42 face each other, and a normal direction of the first main surface 41 and a normal direction of the second main surface 42 substantially coincide with the first direction D1. The outer peripheral surface 43 connects an outer peripheral edge of the first main surface 41 and an outer peripheral edge of the second main surface 42 to each other.

In the second conductor 4, a dimension ratio of a dimension in the second direction D2 to a dimension in the first direction D1 is larger than 1. That is, the second conductor 4 is a planar conductor whose dimension in the radial direction is longer than a dimension in the axial direction.

In the antenna device 1, the first conductor 3 and the second conductor 4 are provided side by side along the first direction D1 so as to sandwich the antenna coil 2. Furthermore, the first conductor 3 and the second conductor 4 are substantially the same in size in a plan view from the first direction D1.

(4.3) Antenna Coil

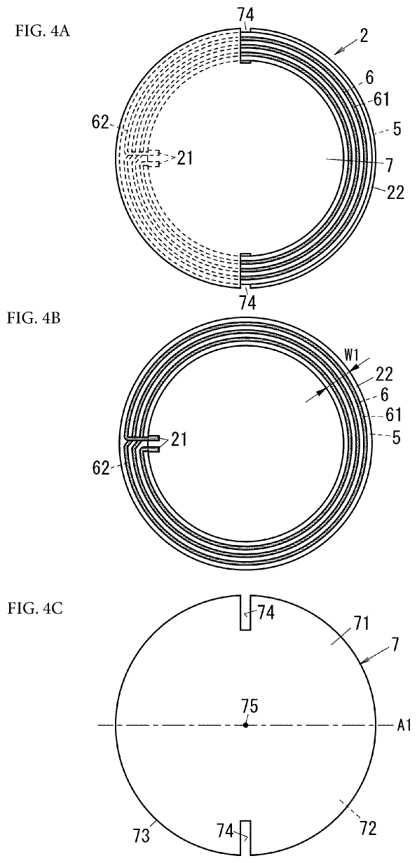

As illustrated in FIG. 1, FIG. 2, FIG. 4A, FIG. 4B, and FIG. 4C, the antenna coil 2 includes a base member 5, a coil conductor 6, and a magnetic body 7. Furthermore, the antenna coil 2 further includes two connection terminals 21 and a protective layer 22. The antenna coil 2 is used for near field communication using magnetic field coupling with the antenna coil 94 (see FIG. 3) of the external apparatus 9. The antenna coil 2 has, for example, a flat plate shape as a whole.

The base member 5 is formed of an electrically insulating material such as a resin or the like in a plate shape or a sheet shape. Examples of the electrically insulating material used for the base member 5 include polyimide, PET (Poly Ethylene Terephthalate), and a Liquid Crystal Polymer (LCP). The base member 5 has a circular annular shape in a plan view from the first direction D1. A width WI (see FIG. 4B) of the base member 5 between an outer peripheral edge and an inner peripheral edge is large enough to provide the coil conductor 6.

The coil conductor 6 is a spiral-shaped coil conductor formed of copper, aluminum, or the like. The coil conductor 6 is provided on a main surface 51 (see FIG. 1) of the base member 5 in a thickness direction (first direction D1) of the base member 5, and is wound around a winding axis along the first direction D1 a plurality of times. For example, through etching or printing, by a copper film or an aluminum film being formed on the base member 5, the coil conductor 6 is provided on the main surface 51 of the base member 5. Here, the spiral-shaped coil conductor may be a two dimensional coil conductor wound in a spiral shape around the winding axis a plurality of times on a single plane, or may be a three dimensional coil conductor wound in a helical shape around the winding axis along the winding axis a plurality of times. FIG. 1, FIG. 2, FIG. 4A, and FIG. 4B each illustrate the two dimensional coil conductor.

The coil conductor 6 includes a first coil conductor portion 61 and a second coil conductor portion 62. The first coil conductor portion 61 is configured of a plurality of (three in the illustrated example) first conductor parts. The second coil conductor portion 62 is configured of a plurality of (three in the illustrated example) second conductor parts.

The first coil conductor portion 61 is provided so as to be positioned on the first conductor 3 side (upper side in FIG. 1) relative to the magnetic body 7 in the first direction D1. That is, the first coil conductor portion 61 is closer to the first conductor 3 in comparison with the magnetic body 7. On the other hand, the second coil conductor portion 62 is provided so as to be positioned on the second conductor 4 side (lower side in FIG. 1) relative to the magnetic body 7 in the first direction D1. That is, the second coil conductor portion 62 is closer to the second conductor 4 in comparison with the magnetic body 7. However, both the first coil conductor portion 61 and the second coil conductor portion 62 are provided on the main surface 51 of the base member 5 in the first direction D1.

The first coil conductor portion 61 and the second coil conductor portion 62 are integrally provided, and the first coil conductor portion 61 and the second coil conductor portion 62 form one loop-shaped coil. That is, a plurality of first conductor parts configuring the first coil conductor portion 61 and a plurality of second conductor parts configuring the second coil conductor portion 62 are alternately connected. Additionally, the first coil conductor portion 61 and the second coil conductor portion 62 are positioned at positions not overlapping with each other in a plan view from the first direction D1. That is, the first coil conductor portion 61 and the second coil conductor portion 62 are positioned at positions not overlapping with each other in a plan view of the magnetic body 7. In other words, a first coil conductor region formed by the plurality of first conductor parts configuring the first coil conductor portion 61 and a second coil conductor region formed by the plurality of second conductor parts configuring the second coil conductor portion 62 do not overlap with each other in a plan view of the magnetic body 7.

The two connection terminals 21 are formed integrally with the coil conductor 6 in order to connect the coil conductor 6 to an external circuit such as the signal processing circuit 81. The two connection terminals 21 are connected to both ends of the coil conductor 6, and are formed so as to be insulated from a portion other than both the ends of the coil conductor 6.

The protective layer 22 covers the coil conductor 6 provided on the base member 5, and protects the base member 5 and the coil conductor 6 from external force or the like. The protective layer 22 is formed of an electrically insulating material such as a resin or the like in a plate shape or a sheet shape. Examples of the electrically insulating material used for the protective layer 22 include polyimide and a liquid crystal polymer. In a plan view from the first direction D1, a planar shape of the protective layer 22 is substantially the same as the shape of the base member 5. The protective layer 22 is affixed to one surface of the base member 5 with an adhesive layer, which is not illustrated, interposed therebetween.

The magnetic body 7 is formed of a ferromagnetic material such as ferrite or the like in a circular plate shape or a circular sheet shape. The magnetic body 7 has a first main surface 71, a second main surface 72, and an outer peripheral surface 73. The first main surface 71 and the second main surface 72 are positioned at both ends of the magnetic body 7, respectively, in a thickness direction (first direction D1). The outer peripheral surface 73 connects the first main surface 71 and the second main surface 72 to each other. The magnetic body 7 has a higher magnetic permeability than those of the first conductor 3, the second conductor 4, the base member 5, and the protective layer 22. Examples of the ferromagnetic material used for the magnetic body 7 include Ni—Zn—Cu based ferrite and hexagonal ferrite.

A thickness of the magnetic body 7 is equal to or more than several tens μm and equal to or less than several hundreds m (i.e., from several tens m to several hundreds μm). For the upper limit, the thickness of the magnetic body 7 is preferably equal to or less than 300 μm, and more preferably equal to or less than 200 μm. On the other hand, for the lower limit, the thickness of the magnetic body 7 is preferably equal to or more than 50 μm, and more preferably equal to or more than 100 μm.

The magnetic body 7 has two recessed portions 74 (see FIG. 2 and FIG. 4A). The two recessed portions 74 are recessed from two positions of the outer peripheral surface 73, respectively, which are line-symmetrical with respect to a symmetry axis A1 including the center 75 of the magnetic body 7 toward a center direction.

The magnetic body 7 is fitted into the coil conductor 6. More specifically, the magnetic body 7 is fitted into the coil conductor 6 such that the coil conductor 6 provided on the annular base member 5 and covered with the annular protective layer 22 passes through the two recessed portions 74 of the magnetic body 7. At this time, the first coil conductor portion 61 is closer to the first main surface 71 than to the second main surface 72 of the magnetic body 7, and the second coil conductor portion 62 is closer to the second main surface 72 than to the first main surface 71 of the magnetic body 7. That is, the first coil conductor portion 61 is positioned not on the second main surface 72 side but on the first main surface 71 side in the first direction D1, and the second coil conductor portion 62 is positioned not on the first main surface 71 side but on the second main surface 72 side in the first direction D1.

The antenna coil 2 having the above-described configuration is positioned between the first conductor 3 and the second conductor 4 in the first direction D1. At this time, the first main surface 71 of the magnetic body 7 faces the first main surface 31 of the first conductor 3 in the first direction D1, and the second main surface 72 of the magnetic body 7 faces the first main surface 41 of the second conductor 4 in the first direction D1. At this time, it is preferable that the first main surface 71 of the magnetic body 7 and the first main surface 31 of the first conductor 3 face each other so as to be parallel to each other along the second direction D2. In the same manner, it is preferable that the second main surface 72 of the magnetic body 7 and the first main surface 41 of the second conductor 4 face each other so as to be parallel to each other along the second direction D2. Note that the antenna coil 2 may make close contact with the first conductor 3 or may be arranged with a gap interposed between the antenna coil and the first conductor 3. In the same manner, the antenna coil 2 may make close contact with the second conductor 4 or may be arranged with a gap interposed between the antenna coil and the second conductor 4.

The first coil conductor portion 61 of the coil conductor 6 is arranged so as to overlap with the first conductor 3 in a plan view from the first direction D1. Furthermore, in the first embodiment, the entire first coil conductor portion 61 is arranged along an edge end of the first conductor 3 in a plan view from the first direction D1. That is, the first coil conductor portion 61 overlaps with the first conductor 3 in a plan view of the magnetic body 7, and the entire first coil conductor portion 61 is arranged along the edge end of the first conductor 3 in a plan view of the magnetic body 7. As an example in which the first coil conductor portion 61 is arranged along the edge end of the first conductor 3, as illustrated in FIG. 1, the first coil conductor portion 61 is arranged so as to oppose a region of the first main surface 31 of the first conductor 3 in which a dimension ratio of a length L21 from the outer peripheral surface 33 to a length L11 of a first line segment is equal to or less than one half. The length L11 of the first line segment is a length of a line segment connecting the center 34 (center of gravity) of the first main surface 31 and the outer peripheral surface 33. Preferably, the first coil conductor portion 61 is arranged so as to oppose a region of the first main surface 31 of the first conductor 3 in which a dimension ratio of the length L21 from the outer peripheral surface 33 to the length L11 of the first line segment is equal to or less than one quarter.

In the same manner, the second coil conductor portion 62 of the coil conductor 6 is arranged so as to overlap with the second conductor 4 in a plan view from the first direction D1. Furthermore, in the first embodiment, the entire second coil conductor portion 62 is arranged along an edge end of the second conductor 4 in a plan view from the first direction D1. That is, the second coil conductor portion 62 overlaps with the second conductor 4 in a plan view of the magnetic body 7, and the entire second coil conductor portion 62 is arranged along the edge end of the second conductor 4 in a plan view of the magnetic body 7. As an example in which the second coil conductor portion 62 is arranged along the edge end of the second conductor 4, as illustrated in FIG. 1, the second coil conductor portion 62 is arranged so as to oppose a region of the first main surface 41 of the second conductor 4 in which a dimension ratio of a length L22 from the outer peripheral surface 43 to a length L12 of a second line segment is equal to or less than one half. The length L12 of the second line segment is a length of a line segment connecting the center 44 (center of gravity) of the first main surface 41 and the outer peripheral surface 43. Preferably, the second coil conductor portion 62 is arranged so as to oppose a region of the first main surface 41 of the second conductor 4 in which a dimension ratio of the length L22 from the outer peripheral surface 43 to the length L12 of the second line segment is equal to or less than one quarter.

(5) Operation of Antenna Device

Next, an operation of the antenna device 1 when the electronic apparatus 8 (see FIG. 3) provided with the antenna device 1 according to the first embodiment communicates with the external apparatus 9 (see FIG. 3) will be described with reference to FIG. 1.

First, a case where the electronic apparatus 8 transmits a signal to the external apparatus 9 will be described.

First, the electronic apparatus 8 and the external apparatus 9 are brought close to each other such that the electronic apparatus 8 and the external apparatus 9 oppose each other in the second direction D2 orthogonal to the first direction D1 along the winding axis of the coil conductor 6 of the antenna device 1. More specifically, the electronic apparatus 8 and the external apparatus 9 are brought close to each other such that the winding axis of the coil conductor 95 (see FIG. 3) of the external apparatus 9 is along the second direction D2.

Then, a current I1 corresponding to the signal transmitted from the electronic apparatus 8 to the external apparatus 9 flows in the coil conductor 6 of the antenna coil 2. Magnetic fluxes φ11 and φ12 are generated in the periphery of the coil conductor 6 by the current I1. More specifically, the magnetic flux φ11 is generated in the periphery of the first coil conductor portion 61, and the magnetic flux φ12 is generated in the periphery of the second coil conductor portion 62.

When the magnetic fluxes φ11 and φ12 are generated by the current I1, an induced current I21 flows in the first conductor 3 so as to cancel a change in the magnetic flux φ11, and an induced current I22 flows in the second conductor 4 so as to cancel a change in the magnetic flux φ12. More specifically, the induced current I21 flows along the edge end of the first conductor 3 by the magnetic flux φ11 based on the current I1 flowing in the first coil conductor portion 61. Furthermore, the induced current I22 flows along the edge end of the second conductor 4 by the magnetic flux φ12 based on the current I1 flowing in the second coil conductor portion 62. A magnetic flux φ21 is generated by the induced current I21 of the first conductor 3, and a magnetic flux φ22 is generated by the induced current I22 of the second conductor 4.

In the antenna device 1, a magnetic flux φ1 generated by the current I1 of the coil conductor 6, the magnetic flux φ21 generated by the induced current I21 flowing in the first conductor 3, and the magnetic flux φ22 generated by the induced current I22 flowing in the second conductor 4 are oriented in the same direction in the vicinity of the magnetic body 7. With the configuration described above, the magnetic flux emitted from the antenna device 1 can be increased, and antenna characteristics of the antenna device 1 can be improved. As a result, when the electronic apparatus 8 and the external apparatus 9 communicate with each other, desired communication characteristics can be secured. In other words, by bringing the first conductor 3 and the second conductor 4 close to the antenna coil 2 from both sides of the antenna coil 2, respectively, the induced currents I21 and I22 flow in the first conductor 3 and the second conductor 4, respectively, such that the magnetic fluxes φ21 and φ22 are generated in the same direction as that of the magnetic flux φ1 emitted from the antenna coil 2 in the second direction D2. This makes it possible to improve the communication characteristics in the second direction D2.

Furthermore, sandwiching the antenna coil 2 between the first conductor 3 and the second conductor 4 makes it possible to change the directivity of the magnetic flux. That is, the direction in which the magnetic flux is largely emitted can be changed from the first direction D1 to the second direction D2. With this, when the electronic apparatus 8 and the external apparatus 9 communicate with each other, the electronic apparatus 8 and the external apparatus 9 are brought close to each other in the second direction D2, it is thus possible to reduce a possibility that the display unit 83 of the electronic apparatus 8 positioned in the first direction D1 with respect to the antenna device 1 makes contact with the external apparatus 9.

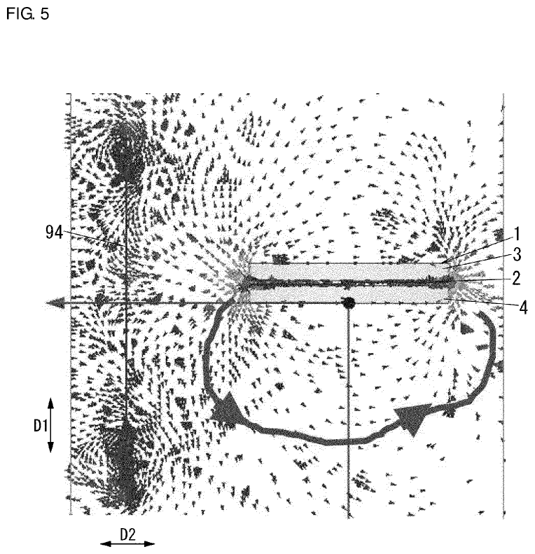

FIG. 5 shows a simulation result of magnetic flux distribution in the antenna device 1 according to the first embodiment. In the simulation result as well, it is clear that a larger magnetic flux is generated from the antenna device 1 in the second direction D2 than in the first direction D1.

Furthermore, a coupling coefficient with the external apparatus 9 (antenna coil 94) in the antenna device 1 (antenna coil 2) according to the first embodiment is increased by equal to or more than 30% with respect to a coupling coefficient with the external apparatus 9 in an antenna device according to a comparative example which does not include the first conductor 3 and the second conductor 4. The coupling coefficient with the external apparatus 9 is a value in a case where the external apparatus 9 is arranged in a direction in which the coupling coefficient increases with respect to the antenna device in both of the first embodiment and the comparative example. Specifically, the coupling coefficient between the antenna device 1 according to the first embodiment and the external apparatus 9 is a coupling coefficient in a case where the external apparatus 9 is arranged in the second direction D2 with respect to the antenna device 1 according to the first embodiment. On the other hand, the coupling coefficient between the antenna device according to the comparative example and the external apparatus 9 is a coupling coefficient in a case where the external apparatus 9 is arranged in the first direction D1 with respect to the antenna device according to the comparative example. For example, in a case where a distance between the antenna device and the external apparatus 9 is 25 mm, the coupling coefficient of the antenna device 1 according to the first embodiment is increased by 37% with respect to the coupling coefficient of the antenna device according to the comparative example.

Next, a case where the electronic apparatus 8 receives a signal from the external apparatus 9 will be described.

First, the electronic apparatus 8 and the external apparatus 9 are brought close to each other such that the electronic apparatus 8 and the external apparatus 9 oppose each other in the second direction D2. Then, a current corresponding to the signal transmitted from the external apparatus 9 to the electronic apparatus 8 flows in the coil conductor 95 of the external apparatus 9. By this current, a magnetic flux is generated in the periphery of the antenna coil 94 (see FIG. 3). Then, the magnetic flux emitted from the external apparatus 9 interlinks with the coil conductor 6 of the electronic apparatus 8, whereby, in the coil conductor 6 of the electronic apparatus 8, electromotive force of a magnitude corresponding to the change in the magnetic flux interlinking with the coil conductor 6 occurs and the induced current flows.

With this, the electronic apparatus 8 can receive the signal from the external apparatus 9.

(6) Modifications

The magnetic body 7 is not limited to having a circular shape in a plan view from the first direction D1, and may have another shape such as a square shape.

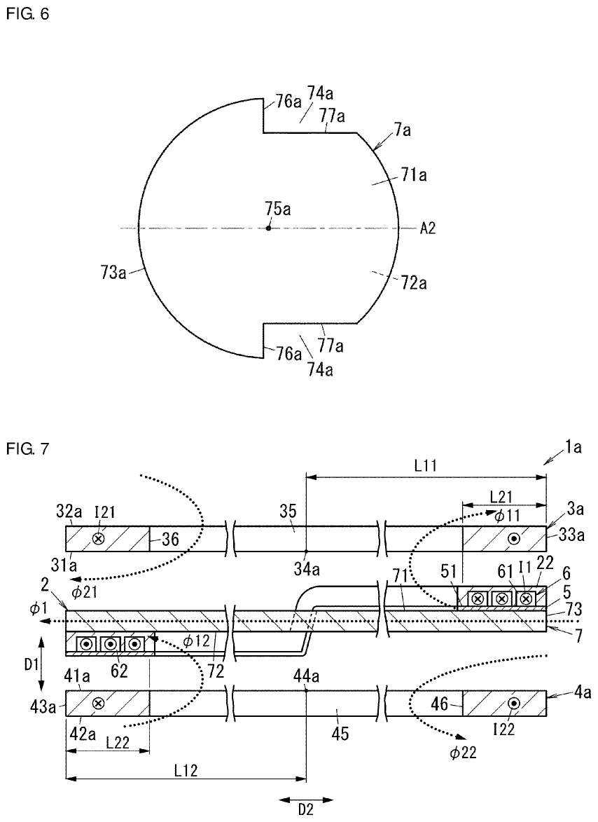

Moreover, as a modification of the first embodiment, the antenna coil 2 may include a magnetic body 7a illustrated in FIG. 6 instead of the magnetic body 7 illustrated in FIG. 4C.

The magnetic body 7a has a first main surface 71a, a second main surface 72a, and an outer peripheral surface 73a. The first main surface 71a and the second main surface 72a are positioned at both ends of the magnetic body 7a, respectively, in a thickness direction (first direction D1). The outer peripheral surface 73a connects the first main surface 71a and the second main surface 72a. Additionally, the magnetic body 7a has two side surfaces 76a extending from two positions of the outer peripheral surface 73a, respectively, which are line-symmetrical with respect to a symmetry axis A2 including the center 75a toward a center direction, and two bottom surfaces 77a extending from the side surfaces 76a, respectively, in a direction along the symmetry axis A2 and connected to the outer peripheral surface 73a. Furthermore, the magnetic body 7a has two recessed portions 74a each surrounded by the side surface 76a and the bottom surface 77a. In the present modification, the magnetic body 7a is fitted into the coil conductor 6 such that the coil conductor 6 provided on the annular base member 5 and covered with the annular protective layer 22 passes through the two recessed portions 74a of the magnetic body 7a.

The first main surface 71 (71a) of the magnetic body 7 (7a) and the first main surface 31 of the first conductor 3 are not limited to being parallel to each other along the second direction D2. It is sufficient that the first main surface 71 (71a) of the magnetic body 7 (7a) and the first main surface 31 of the first conductor 3 face each other in the first direction D1 even if they are not parallel to each other along the second direction D2. In the same manner, the second main surface 72 (72a) of the magnetic body 7 (7a) and the first main surface 41 of the second conductor 4 are not limited to being parallel to each other along the second direction D2. It is sufficient that the second main surface 72 (72a) of the magnetic body 7 (7a) and the first main surface 41 of the second conductor 4 face each other in the first direction D1 even if they are not parallel to each other along the second direction D2.

The coil conductor 6 is not limited to having a circular annular shape, and may have an annular shape of a shape, such as an ellipse or a polygon, other than the circle.

The first conductor 3 and the second conductor 4 are not limited to having a circular shape, and may have a shape, such as an ellipse or a polygon, other than the circle.

The antenna coil 2 is not limited to a configuration in which the coil conductor 6 is formed on the base member 5 made of the electrically insulating material such as resin, and may have a configuration, for example, in which a magnetic body is used as a base member, and the coil conductor is formed on this base member.

In addition, in the coil conductor 6, the entire first coil conductor portion 61 is not limited to being arranged along the edge end of the first conductor 3 in a plan view of the magnetic body 7. The first coil conductor portion 61 may have both a portion arranged along the edge end of the first conductor 3 and a portion not arranged along the edge end of the first conductor 3. In short, at least a part of the first coil conductor portion 61 may be arranged along the edge end of the first conductor 3 in a plan view of the magnetic body 7.

In the same manner, the entire second coil conductor portion 62 is not limited to being arranged along the edge end of the second conductor 4 in a plan view of the magnetic body 7. The second coil conductor portion 62 may have both a portion arranged along the edge end of the second conductor 4 and a portion not arranged along the edge end of the second conductor 4. In short, at least a part of the second coil conductor portion 62 may be arranged along the edge end of the second conductor 4 in a plan view of the magnetic body 7.

The dimensions and shape of the first conductor 3 and the dimensions and shape of the second conductor 4 may be the same or different.

The number of first conductors 3 is not limited to one, and the antenna device 1 may include a plurality of first conductors. In the same manner, the number of second conductors 4 is not limited to one, and the antenna device 1 may include a plurality of second conductors.

The antenna device 1 is not limited to an active tag, and may be a passive tag or a semi-active tag. In the case of the passive tag, the antenna device 1 may not include the power feeding circuit 82 (see FIG. 3) for feeding electric power to the antenna coil 2.

The antenna coil 2 is not limited to having a flat plate shape. Furthermore, the antenna coil 2 may be bent. For example, the magnetic body 7 is not limited to having a flat plate shape. The first main surface 71 of the magnetic body 7 is not limited to the flat surface, and may have at least one of a bent portion and a curved portion. In the same manner, the second main surface 72 of the magnetic body 7 is not limited to the flat surface, and may have at least one of a bent portion and a curved portion.

(7) Effects

As described above, in the antenna device 1 according to the first embodiment, the first coil conductor portion 61 overlaps with the first conductor 3 in a plan view of the magnetic body 7, and at least a part of the first coil conductor portion 61 is arranged along the edge end of the first conductor 3. Furthermore, the second coil conductor portion 62 overlaps with the second conductor 4 in a plan view of the magnetic body 7, and at least a part of the second coil conductor portion 62 is arranged along the edge end of the second conductor 4. With this configuration, unlike the case where the first conductor and the second conductor each have a slit, the first conductor 3 and the second conductor 4 do not deteriorate in strength. That is, the strength of the antenna device 1 is not reduced. Additionally, since the induced currents I21 and I22 generated in the first conductor 3 and the second conductor 4 can generate the magnetic fluxes φ21 and φ22, respectively, in the second direction D2 orthogonal to the winding axis of the coil conductor 6, the magnetic flux in the second direction D2 from the antenna device 1 can be increased. As a result, the antenna characteristics can be improved.

In the antenna device 1 according to the first embodiment, the entire first coil conductor portion 61 is arranged along the edge end of the first conductor 3. With this configuration, since portions of the first coil conductor portion 61 close to the edge end of the first conductor 3 are increased, the induced current I21 can be made easy to be generated in the first conductor 3.

In the antenna device 1 according to the first embodiment, the entire second coil conductor portion 62 is arranged along the edge end of the second conductor 4. With this configuration, since portions of the second coil conductor portion 62 close to the edge end of the second conductor 4 are increased, the induced current I22 can be made easy to be generated in the second conductor 4.

In the electronic apparatus 8 according to the first embodiment, the display unit 83 is provided on the opposite side from the antenna coil 2 with respect to the first conductor 3 in the first direction D1. Even when the display unit 83 is provided as described above, the communication between the electronic apparatus 8 and the external apparatus 9 can be performed while reducing contact of the display unit 83 with the external apparatus 9 which is the communication target of the electronic apparatus 8.

### Second Embodiment

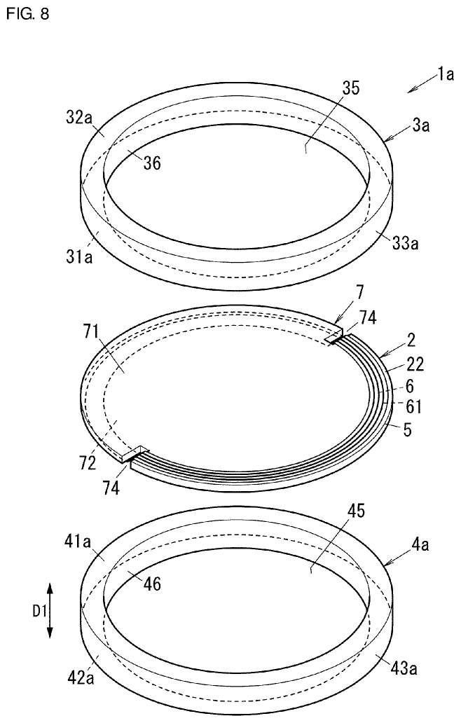

As illustrated in FIG. 7 and FIG. 8, an antenna device 1a according to a second embodiment differs from the antenna device 1 (see FIG. 1 and FIG. 2) according to the first embodiment in a point that a first conductor 3a and a second conductor 4a each have a ring shape. Note that the same constituent elements as those of the antenna device 1 according to the first embodiment are denoted by the same reference numerals, and description thereof will be omitted.

As illustrated in FIG. 7 and FIG. 8, the first conductor 3a is formed of a metal or the like in a ring shape. An axial direction of the first conductor 3a coincides with the first direction D1. The first conductor 3a has a first main surface 31a, a second main surface 32a, an outer peripheral surface 33a, and an inner peripheral surface 36. Additionally, the first conductor 3a has an internal space 35 that penetrates therethrough in the first direction D1. The first main surface 31a and the second main surface 32a each have an annular shape and are positioned at both ends of the first conductor 3a, respectively, in the axial direction (first direction D1). Additionally, the first main surface 31a and the second main surface 32a face each other, and a normal direction of the first main surface 31a and a normal direction of the second main surface 32a substantially coincide with the first direction D1. The outer peripheral surface 33a connects an outer peripheral edge of the first main surface 31a and an outer peripheral edge of the second main surface 32a to each other. The inner peripheral surface 36 connects an inner peripheral edge of the first main surface 31a and an inner peripheral edge of the second main surface 32a to each other.

In the first conductor 3a, a dimension ratio of a dimension in the second direction D2 to a dimension in the first direction D1 is larger than 1. That is, the first conductor 3a is a ring-shaped conductor whose dimension in the radial direction is longer than a dimension in the axial direction.

Here, in the first conductor 3a, the internal space 35 is covered with the inner peripheral surface 36 in all directions orthogonal to the first direction D1. That is, in the first conductor 3a, the internal space 35 is closed in all directions orthogonal to the first direction D1.

Similarly, the second conductor 4a is formed of a metal or the like in a ring shape. An axial direction of the second conductor 4a coincides with the first direction D1. The second conductor 4a has a first main surface 41a, a second main surface 42a, an outer peripheral surface 43a, and an inner peripheral surface 46. Additionally, the second conductor 4a has an internal space 45 that penetrates therethrough in the first direction D1. The first main surface 41a and the second main surface 42a each have an annular shape and are positioned at both ends of the second conductor 4a, respectively, in the axial direction (first direction D1). Additionally, the first main surface 41a and the second main surface 42a face each other, and a normal direction of the first main surface 41a and a normal direction of the second main surface 42a substantially coincide with the first direction D1. The outer peripheral surface 43a connects an outer peripheral edge of the first main surface 41a and an outer peripheral edge of the second main surface 42a to each other. The inner peripheral surface 46 connects an inner peripheral edge of the first main surface 41a and an inner peripheral edge of the second main surface 42a to each other.

In the second conductor 4a, a dimension ratio of a dimension in the second direction D2 to a dimension in the first direction D1 is larger than 1. That is, the second conductor 4a is a ring-shaped conductor whose dimension in the radial direction is longer than a dimension in the axial direction.

Here, in the second conductor 4a as well, in the same manner as in the first conductor 3a, the internal space 45 is covered with the inner peripheral surface 46 in all directions orthogonal to the first direction D1. That is, in the second conductor 4a, the internal space 45 is closed in all directions orthogonal to the first direction D1.

The first conductor 3a and the second conductor 4a are provided side by side along the first direction D1. Furthermore, the first conductor 3a and the second conductor 4a are substantially the same in size in a plan view from the first direction D1.

In the same manner as the antenna coil 2 (see FIG. 2) according to the first embodiment, the antenna coil 2 according to the second embodiment is positioned between the first conductor 3a and the second conductor 4a in the first direction D1. At this time, the first main surface 71 of the magnetic body 7 faces the first main surface 31a of the first conductor 3a in the first direction D1, and the second main surface 72 of the magnetic body 7 faces the first main surface 41a of the second conductor 4a in the first direction D1. Note that description of the same functions as those of the antenna coil 2 (see FIG. 1) according to the first embodiment will be omitted.

In the antenna device 1a according to the second embodiment, the entire first coil conductor portion 61 of the coil conductor 6 is arranged along an edge end of the first conductor 3a in a plan view from the first direction D1. That is, the entire first coil conductor portion 61 is arranged along the edge end of the first conductor 3a in a plan view of the magnetic body 7. According to the second embodiment, although the first conductor 3a has the ring shape and the first main surface 31a of the first conductor 3a has the annular shape, the first coil conductor portion 61 is provided so as to oppose the first main surface 31a of the first conductor 3a in the first direction D1. In the same manner as the first coil conductor portion 61 (see FIG. 1) according to the first embodiment, as illustrated in FIG. 7, the first coil conductor portion 61 is arranged so as to oppose a region of the first main surface 31a of the first conductor 3a in which a dimension ratio of the length L21 from the outer peripheral surface 33a to the length L11 of the first line segment is equal to or less than one half. The length L11 of the first line segment in the second embodiment is a length of a line segment connecting the center 34a (center of gravity) of the first main surface 31a and the outer peripheral surface 33a. Preferably, the first coil conductor portion 61 is arranged so as to oppose a region of the first main surface 31a of the first conductor 3a in which a dimension ratio of the length L21 from the outer peripheral surface 33a to the length L11 of the first line segment is equal to or less than one quarter.

In the same manner, the entire second coil conductor portion 62 is arranged along an edge end of the second conductor 4a in a plan view from the first direction D1. That is, the entire second coil conductor portion 62 is arranged along the edge end of the second conductor 4a in a plan view of the magnetic body 7. According to the second embodiment, although the second conductor 4a has the ring shape and the first main surface 41a of the second conductor 4a has the annular shape, the second coil conductor portion 62 is provided so as to oppose the first main surface 41a of the second conductor 4a in the first direction D1. In the same manner as the second coil conductor portion 62 (see FIG. 1) according to the first embodiment, as illustrated in FIG. 7, the second coil conductor portion 62 is arranged so as to oppose a region of the first main surface 41a of the second conductor 4a in which a dimension ratio of the length L22 from the outer peripheral surface 43a to the length L12 of the second line segment is equal to or less than one half. The length L12 of the second line segment in the second embodiment is a length of a line segment connecting the center 44a (center of gravity) of the first main surface 41a and the outer peripheral surface 43a. Preferably, the second coil conductor portion 62 is arranged so as to oppose a region of the first main surface 41a of the second conductor 4a in which a dimension ratio of the length L22 from the outer peripheral surface 43a to the length L12 of the second line segment is equal to or less than one quarter.

Next, an operation of the antenna device 1a when the electronic apparatus 8 (see FIG. 3) provided with the antenna device 1a according to the second embodiment communicates with the external apparatus 9 (see FIG. 3) will be described with reference to FIG. 7.

First, a case where the electronic apparatus 8 transmits a signal to the external apparatus 9 will be described.

First, in the same manner as in the first embodiment, the electronic apparatus 8 and the external apparatus 9 are brought close to each other such that the electronic apparatus 8 and the external apparatus 9 oppose each other in the second direction D2. More specifically, the electronic apparatus 8 and the external apparatus 9 are brought close to each other such that the winding axis of the coil conductor 95 (see FIG. 3) of the external apparatus 9 is along the second direction D2.

Then, the current I1 corresponding to the signal transmitted from the electronic apparatus 8 to the external apparatus 9 flows in the coil conductor 6 of the antenna coil 2. By the current I1, the magnetic flux φ11 is generated in the periphery of the first coil conductor portion 61, and the magnetic flux φ12 is generated in the periphery of the second coil conductor portion 62.

When the magnetic fluxes φ11 and φ12 are generated by the current I1, the induced current I21 flows in the first conductor 3a so as to cancel a change in the magnetic flux φ11, and the induced current I22 flows in the second conductor 4a so as to cancel a change in the magnetic flux φ12. More specifically, the induced current I21 flows along the edge end of the first conductor 3a by the magnetic flux φ11 based on the current I1 flowing in the first coil conductor portion 61. Furthermore, the induced current I22 flows along the edge end of the second conductor 4a by the magnetic flux φ12 based on the current I1 flowing in the second coil conductor portion 62. The magnetic flux φ21 is generated by the induced current I21 of the first conductor 3a, and the magnetic flux φ22 is generated by the induced current I22 of the second conductor 4a.

In the antenna device 1a, the magnetic fluxes φ11 and φ12 generated by the current I1 of the coil conductor 6, the magnetic flux φ21 generated by the induced current I21 flowing in the first conductor 3a, and the magnetic flux φ22 generated by the induced current I22 flowing in the second conductor 4a are oriented in the same direction. With the configuration described above, the magnetic flux from the antenna device 1a can be increased, and antenna characteristics of the antenna device 1a can be improved. As a result, when the electronic apparatus 8 and the external apparatus 9 communicate with each other, desired communication characteristics can be secured.

Next, a case where the electronic apparatus 8 receives a signal from the external apparatus 9 will be described.

In the same manner as in the first embodiment, first, the electronic apparatus 8 and the external apparatus 9 are brought close to each other such that the electronic apparatus 8 and the external apparatus 9 oppose each other in the second direction D2. Then, a current corresponding to the signal transmitted from the external apparatus 9 to the electronic apparatus 8 flows in the coil conductor 95 of the external apparatus 9. By this current, a magnetic flux is generated in the periphery of the antenna coil 94 (see FIG. 3). Then, the magnetic flux emitted from the external apparatus 9 interlinks with the coil conductor 6 of the electronic apparatus 8, whereby, in the coil conductor 6, electromotive force of a magnitude corresponding to the change in the magnetic flux interlinking with the coil conductor 6 occurs and the induced current flows.

With this, the electronic apparatus 8 can receive the signal from the external apparatus 9.

Next, a case where the electronic apparatus 8 and the external apparatus 9 oppose each other in the first direction D1 along the winding axis of the coil conductor 6 of the antenna device 1a will be described.

First, a case where the electronic apparatus 8 transmits a signal to the external apparatus 9 will be described.

First, the electronic apparatus 8 and the external apparatus 9 are brought close to each other such that the electronic apparatus 8 and the external apparatus 9 oppose each other in the first direction D1. More specifically, the electronic apparatus 8 and the external apparatus 9 are brought close to each other such that the winding axis of the coil conductor 6 of the electronic apparatus 8 is along the winding axis of the coil conductor 95 of the external apparatus 9. At this time, the electronic apparatus 8 and the external apparatus 9 are brought close to each other such that the antenna coil 94 is positioned by being shifted from the center of the first conductor 3a in the second direction D2 instead of the antenna coil 94 of the external apparatus 9 being positioned directly above the first conductor 3a. That is, the electronic apparatus 8 and the external apparatus 9 are brought close to each other such that the winding axis of the coil conductor 95 of the external apparatus 9 is shifted in the second direction D2 with respect to the winding axis of the coil conductor 6 of the electronic apparatus 8.

Then, when the current I1 corresponding to the signal transmitted from the electronic apparatus 8 to the external apparatus 9 flows in the coil conductor 6 of the antenna coil 2, the magnetic flux φ11 is generated in the periphery of the coil conductor 6.

In the first embodiment, since the magnetic flux φ11 based on the current I1 flowing in the coil conductor 6 is generated so as to pass through the magnetic body 7 and greatly turn around the first conductor 3 and the second conductor 4, even if the electronic apparatus 8 and the external apparatus 9 oppose each other in the first direction D1, the magnetic flux hardly interlinks with the antenna coil 94 of the external apparatus 9.

In contrast, in the second embodiment, since the first conductor 3a has the ring shape and has the internal space 35, when the antenna coil 94 of the external apparatus 9 opposes only half of the first conductor 3a (right half in FIG. 7), the magnetic flux φ11 passes through an outer side portion and the internal space 35 of the first conductor 3a and interlinks with the antenna coil 94, and thus an induced current flows in the antenna coil 94. Furthermore, when the antenna coil 94 of the external apparatus 9 opposes only the remaining half of the first conductor 3a (left half in FIG. 7), the magnetic flux φ21 passes through an outer side portion and the internal space 35 of the first conductor 3a and interlinks with the antenna coil 94, and thus an induced current flows in the antenna coil 94.

Next, a case where the electronic apparatus 8 receives a signal from the external apparatus 9 will be described.

First, the electronic apparatus 8 and the external apparatus 9 are brought close to each other such that the electronic apparatus 8 and the external apparatus 9 oppose each other in the first direction D1. Then, a current corresponding to the signal transmitted from the external apparatus 9 to the electronic apparatus 8 flows in the coil conductor 95 of the external apparatus 9. By this current, a magnetic flux is generated in the periphery of the antenna coil 94. Then, the magnetic flux emitted from the external apparatus 9 interlinks with the coil conductor 6 of the electronic apparatus 8 with the internal space 35 of the first conductor 3a interposed therebetween, whereby, in the coil conductor 6 of the electronic apparatus 8, electromotive force of a magnitude corresponding to the change in the magnetic flux interlinking with the coil conductor 6 occurs and the induced current flows.

With the configuration described above, the electronic apparatus 8 can receive the signal from the external apparatus 9.

With this, not only when the electronic apparatus 8 and the external apparatus 9 oppose each other in the second direction D2, but also when the electronic apparatus 8 and the external apparatus 9 oppose each other in the first direction D1, the communication between the electronic apparatus 8 and the external apparatus 9 can be performed.

Note that in the second embodiment, both the first conductor 3a and the second conductor 4a are not limited to having a ring shape. Only the first conductor 3a may have the ring shape, or only the second conductor 4a may have the ring shape. In short, it is sufficient that at least one of the first conductor 3a and the second conductor 4a has the ring shape.

The antenna coil 2 according to the second embodiment is not limited to having a flat plate shape. Furthermore, the antenna coil 2 may be bent. For example, the magnetic body 7 is not limited to having a flat plate shape. The first main surface 71 of the magnetic body 7 is not limited to the flat surface, and may have at least one of a bent portion and a curved portion. In the same manner, the second main surface 72 of the magnetic body 7 is not limited to the flat surface, and may have at least one of a bent portion and a curved portion.

As described above, in the antenna device 1a according to the second embodiment, at least one of the first conductor 3a and the second conductor 4a has the ring shape. As a result, the magnetic flux not only in the second direction D2 orthogonal to the winding axis of the coil conductor 6, but also in the first direction D1 along the winding axis can be increased.

### Third Embodiment

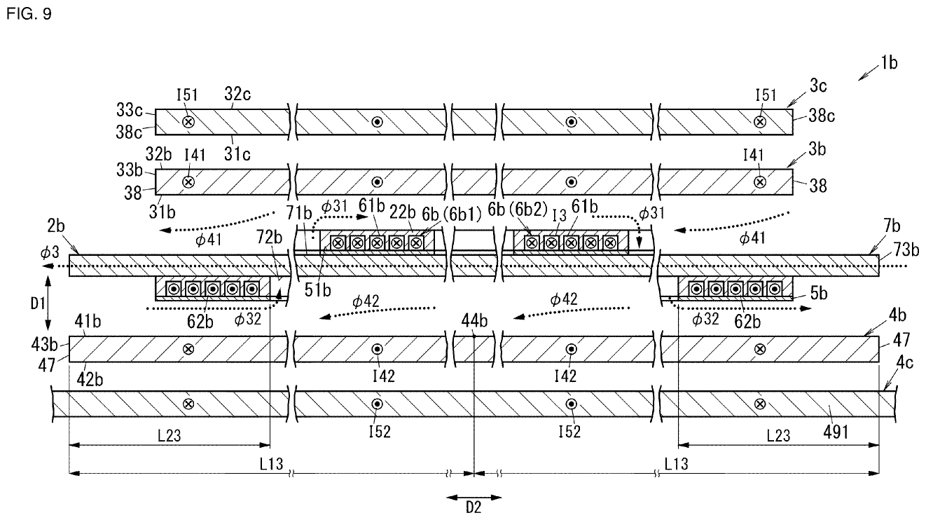

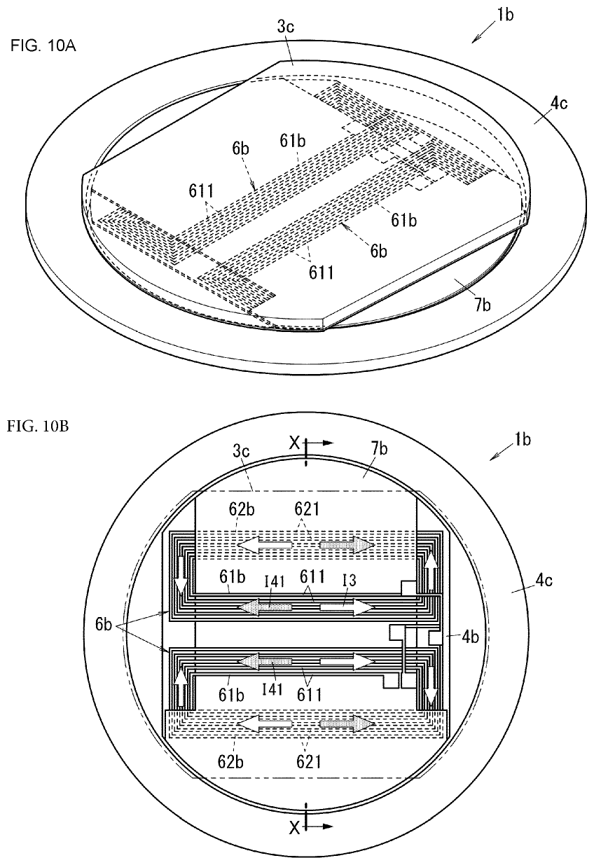

As illustrated in FIG. 9, FIG. 10A, and FIG. 10B, an antenna device 1b according to a third embodiment is different from the antenna device 1 (see FIG. 1 and FIG. 2) according to the first embodiment in a point that a plurality of (two in the illustrated example) coil conductors 6b is included. Note that the same constituent elements as those of the antenna device 1 according to the first embodiment are denoted by the same reference numerals, and description thereof will be omitted.

(1) Antenna Device

As illustrated in FIG. 9, FIG. 10A, and FIG. 10B, the antenna device 1b includes an antenna coil 2b, a first conductor 3b, a second conductor 4b, a third conductor 3c, and a fourth conductor 4c.

(1.1) First Conductor

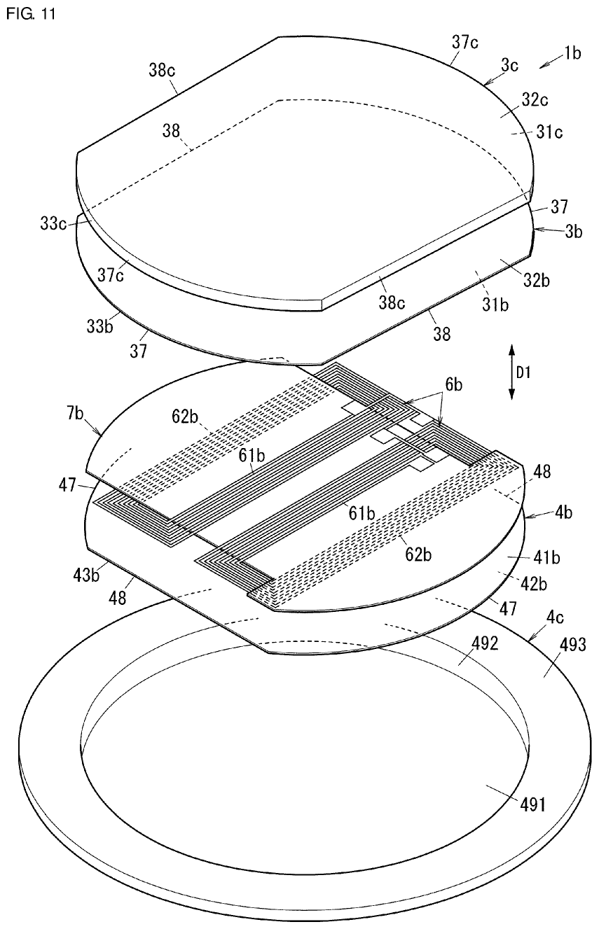

As illustrated in FIG. 9 and FIG. 11, the first conductor 3b is formed of a metal or the like such as copper in a partially lacked disc shape. The first conductor 3b has a first main surface 31b, a second main surface 32b, and an outer peripheral surface 33b. The first main surface 31b and the second main surface 32b each have a partially lacked circular shape, and are positioned at both ends of the first conductor 3b, respectively, in the thickness direction (first direction D1).

In the first conductor 3b, a dimension ratio of a dimension in the second direction D2 to a dimension in the first direction D1 is larger than 1. That is, the first conductor 3b is a planar conductor whose dimension in a planar direction is longer than a dimension in a thickness direction. Note that in the third embodiment, the second direction D2 refers to, when the two coil conductors 6b are viewed from the direction D1, a direction connecting two coil conductor 6b1 and coil conductor 6b2 (a direction connecting the center of gravity of an opening of the coil conductor 6b1 and the center of gravity of an opening of the coil conductor 6b2). That is, in the third embodiment, the second direction D2 means the direction illustrated in FIG. 9.

The first conductor 3b has two first outer edges 37 opposing each other and two second outer edges 38 opposing each other. The two first outer edges 37 each have an arc shape. On the other hand, the two second outer edges 38 each have a linear shape. The two first outer edges 37 oppose each other in a direction orthogonal to the second direction D2. The two second outer edges 38 oppose each other in the second direction D2.

(1.2) Second Conductor

As illustrated in FIG. 9 and FIG. 11, the second conductor 4b is formed of a metal or the like such as copper in a partially lacked disc shape. The second conductor 4b has a first main surface 41b, a second main surface 42b, and an outer peripheral surface 43b. The first main surface 41b and the second main surface 42b each have a partially lacked circular shape, and are positioned at both ends of the second conductor 4b, respectively, in the thickness direction (first direction D1).

In the second conductor 4b, a dimension ratio of a dimension in the second direction D2 to a dimension in the first direction D1 is larger than 1. That is, the second conductor 4b is a planar conductor whose dimension in a planar direction is longer than a dimension in a thickness direction.

The second conductor 4b has two first outer edges 47 opposing each other and two second outer edges 48 opposing each other. The two first outer edges 47 each have an arc shape. On the other hand, the two second outer edges 48 each have a linear shape. The two first outer edges 47 oppose each other in the second direction D2. The two second outer edges 48 oppose each other in a direction orthogonal to the second direction D2.

In the antenna device 1b, the first conductor 3b and the second conductor 4b are provided side by side along the first direction D1 so as to sandwich the antenna coil 2b.

(1.3) Third Conductor

As illustrated in FIG. 9 and FIG. 11, the third conductor 3c is formed of a metal or the like such as stainless steel in a partially lacked disc shape. The third conductor 3c has a first main surface 31c, a second main surface 32c, and an outer peripheral surface 33c. The first main surface 31c and the second main surface 32c each have a partially lacked circular shape, and are positioned at both ends of the third conductor 3c, respectively, in the thickness direction (first direction D1).

In the third conductor 3c, a dimension ratio of a dimension in the second direction D2 to a dimension in the first direction D1 is larger than 1. That is, the third conductor 3c is a planar conductor whose dimension in a planar direction is longer than a dimension in a thickness direction.

The third conductor 3c has two first outer edges 37c opposing each other and two second outer edges 38c opposing each other. The two first outer edges 37c each have an arc shape. On the other hand, the two second outer edges 38c each have a linear shape. The two first outer edges 37c oppose each other in a direction orthogonal to the second direction D2. The two second outer edges 38c oppose each other in the second direction D2.

(1.4) Fourth Conductor

As illustrated in FIG. 9 and FIG. 11, the fourth conductor 4c is formed of a metal or the like such as stainless steel in a box shape whose one surface is opened. The fourth conductor 4c includes a bottom surface portion 491, a side surface portion 492, and a flange portion 493. The bottom surface portion 491 is formed in a disc shape. The side surface portion 492 is formed in a cylindrical shape. The flange portion 493 is formed in an annular shape. The bottom surface portion 491, the side surface portion 492, and the flange portion 493 are formed integrally.

(1.5) Antenna Coil

As illustrated in FIG. 9, FIG. 10A, FIG. 10B, and FIG. 11, the antenna coil 2b includes a base member 5b, the plurality of (two in the illustrated example) coil conductors 6b, and a magnetic body 7b. The antenna coil 2b is used for near field communication using magnetic field coupling with the antenna coil 94 (see FIG. 3) of the external apparatus 9. The antenna coil 2b has, for example, a flat plate shape as a whole.

The base member 5b is formed of an electrically insulating material such as a resin or the like in a plate shape or a sheet shape. Examples of the electrically insulating material used for the base member 5b include polyimide, PET, and a liquid crystal polymer.

The plurality of coil conductors 6b is provided adjacent to each other in the second direction D2. More specifically, each of the coil conductors 6b is a spiral-shaped coil conductor formed of copper, aluminum, or the like. Each of the coil conductors 6b is provided on a main surface 51b (see FIG. 9) of the base member 5b in a thickness direction (first direction D1) of the base member 5b, and is wound around a winding axis along the first direction D1 a plurality of times. For example, through etching or printing, by a copper film or an aluminum film being formed on the base member 5b, each of the coil conductors 6b is provided on the main surface 51b of the base member 5b. Here, the spiral-shaped coil conductor may be a two dimensional coil conductor wound in a spiral shape around the winding axis a plurality of times on a single plane, or may be a three dimensional coil conductor wound in a helical shape around the winding axis along the winding axis a plurality of times. FIG. 9, FIG. 10A, FIG. 10B, and FIG. 11 each illustrate the two dimensional coil conductor.

Each of the coil conductors 6b includes a first coil conductor portion 61b and a second coil conductor portion 62b. The first coil conductor portion 61b is configured of a plurality of (five in the illustrated example, that is, five conductor lines) first conductor parts 611. The second coil conductor portion 62b is configured of a plurality of (five in the illustrated example, that is, five conductor lines) second conductor parts 621.

The first coil conductor portion 61b is provided so as to be positioned on the first conductor 3b side (upper side in FIG. 9) relative to the magnetic body 7b in the first direction D1. That is, the first coil conductor portion 61b is closer to the first conductor 3b in comparison with the magnetic body 7b. On the other hand, the second coil conductor portion 62b is provided so as to be positioned on the second conductor 4b side (lower side in FIG. 9) relative to the magnetic body 7b in the first direction D1. That is, the second coil conductor portion 62b is closer to the second conductor 4b in comparison with the magnetic body 7b.

In each of the coil conductors 6b, the first coil conductor portion 61b and the second coil conductor portion 62b are integrally provided, and the first coil conductor portion 61b and the second coil conductor portion 62b form one loop-shaped coil. That is, the plurality of first conductor parts 611 configuring the first coil conductor portion 61b and the plurality of second conductor parts 621 configuring the second coil conductor portion 62b are alternately connected. Additionally, the first coil conductor portion 61b and the second coil conductor portion 62b are positioned at positions not overlapping with each other in a plan view from the first direction D1. That is, the first coil conductor portion 61b and the second coil conductor portion 62b are positioned at positions not overlapping with each other in a plan view of the magnetic body 7b. In other words, a first coil conductor region formed by the plurality of first conductor parts 611 configuring the first coil conductor portion 61b and a second coil conductor region formed by the plurality of second conductor parts 621 configuring the second coil conductor portion 62b do not overlap with each other in a plan view of the magnetic body 7b.

Furthermore, the plurality of coil conductors 6b is electrically connected to each other. In the example illustrated in FIG. 9, the first coil conductor portions 61b are connected to each other.

A protective layer 22b covers the plurality of coil conductors 6b provided on the base member 5b, and protects the base member 5b and the plurality of coil conductors 6b from external force or the like. The protective layer 22b is formed of an electrically insulating material such as a resin or the like in a plate shape or a sheet shape. Examples of the electrically insulating material used for the protective layer 22b include polyimide and a liquid crystal polymer. In a plan view from the first direction D1, a planar shape of the protective layer 22b is substantially the same as the shape of the base member 5b. The protective layer 22b is affixed to the main surface 51b of the base member 5b with an adhesive layer, which is not illustrated, interposed therebetween.

The magnetic body 7b is formed of a ferromagnetic material such as ferrite or the like in a plate shape or a sheet shape. The magnetic body 7b has higher magnetic permeability than those of the first conductor 3b, the second conductor 4b, the base member 5b, and the protective layer 22b. Examples of the ferromagnetic material used for the magnetic body 7b include Ni—Zn—Cu based ferrite and hexagonal ferrite.

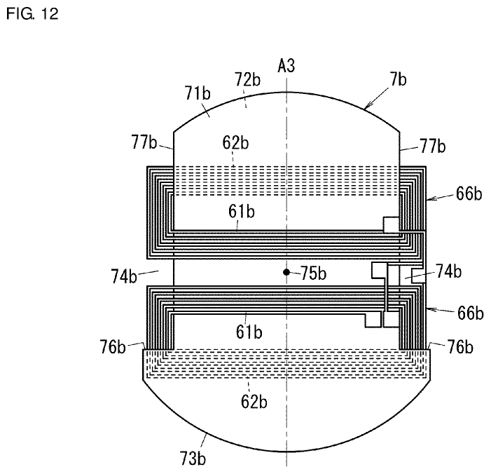

As illustrated in FIG. 12, the magnetic body 7b has a first main surface 71b, a second main surface 72b, and an outer peripheral surface 73b. The first main surface 71b and the second main surface 72b are positioned at both ends of the magnetic body 7b, respectively, in a thickness direction (first direction D1). The outer peripheral surface 73b connects the first main surface 71b and the second main surface 72b. Additionally, the magnetic body 7b has two first side surfaces 76b extending from two positions of the outer peripheral surface 73b, respectively, which are line-symmetrical with respect to a symmetry axis A3 including the center 75b toward the symmetry axis A3, and two second side surfaces 77b extending from the first side surfaces 76b, respectively, in a direction along the symmetry axis A3 and connected to the outer peripheral surface 73b. Furthermore, the magnetic body 7b has two recessed portions 74b each surrounded by the first side surface 76b and the second side surface 77b.

The magnetic body 7b is fitted into the plurality of coil conductors 6b. More specifically, the magnetic body 7b is fitted into the plurality of coil conductors 6b such that the plurality of coil conductors 6b each provided on the annular base member 5b (see FIG. 9) passes through the two recessed portions 74b of the magnetic body 7b. At this time, in each of the coil conductors 6b, the first coil conductor portion 61b is closer to the first main surface 71b than to the second main surface 72b of the magnetic body 7b, and the second coil conductor portion 62b is closer to the second main surface 72b than to the first main surface 71b of the magnetic body 7b. That is, the first coil conductor portion 61b is positioned not on the second main surface 72b side but on the first main surface 71b side in the first direction D1, and the second coil conductor portion 62b is positioned not on the first main surface 71b side but on the second main surface 72b side in the first direction D1.

A thickness of the magnetic body 7b is equal to or more than several tens μm and equal to or less than several hundreds μm (i.e., from several tens μm to several hundreds μm). For the upper limit, the thickness of the magnetic body 7b is preferably equal to or less than 300 μm, and more preferably equal to or less than 200 μm. On the other hand, for the lower limit, the thickness of the magnetic body 7b is preferably equal to or more than 50 μm, and more preferably equal to or more than 100 μm.

The outer edge of the magnetic body 7b is positioned in an outer side portion relative to the outer edge of the coil conductor 6b in the second direction D2 (that is, when the magnetic body 7b is viewed in a plan view along the first direction D1). The antenna coil 2b is in a state of being sandwiched between the first conductor 3b and the third conductor 3c and the second conductor 4b and the fourth conductor 4c in the first direction D1, and both ends of the magnetic body 7b are in a state of being exposed to the outside in the second direction D2. With this configuration, the magnetic flux passing through the magnetic body 7b can be easily emitted to the outside, and the antenna characteristics can be further improved.

The antenna coil 2b having the above-described configuration is positioned between the first conductor 3b and the second conductor 4b in the first direction D1. Additionally, the first conductor 3b, the antenna coil 2b, and the second conductor 4b are positioned between the third conductor 3c and the fourth conductor 4c in the first direction D1. At this time, the first main surface 71b of the magnetic body 7b faces the first main surface 31b of the first conductor 3b in the first direction D1, and the second main surface 72b of the magnetic body 7b faces the first main surface 41b of the second conductor 4b in the first direction D1. Note that the antenna coil 2b may make close contact with the first conductor 3b or may be arranged with a gap interposed between the antenna coil and the first conductor 3b. In the same manner, the antenna coil 2b may make close contact with the second conductor 4b or may be arranged with a gap interposed between the antenna coil and the second conductor 4b.

In each of the plurality of coil conductors 6b, as illustrated in FIG. 9 and FIG. 11, the first coil conductor portion 61b is arranged so as to overlap with the first conductor 3b in a plan view from the first direction D1.

In each of the plurality of coil conductors 6b, as illustrated in FIG. 9 and FIG. 11, the second coil conductor portion 62b is arranged so as to overlap with the second conductor 4b in a plan view from the first direction D1. Furthermore, in the third embodiment, the second coil conductor portion 62b is arranged along an edge end of the second conductor 4b in a plan view from the first direction D1. That is, the second coil conductor portion 62b overlaps with the second conductor 4b in a plan view of the magnetic body 7b, and is arranged along the edge end of the second conductor 4b in a plan view of the magnetic body 7b. As an example in which the second coil conductor portion 62b is arranged along the edge end of the second conductor 4b, as illustrated in FIG. 9, the second coil conductor portion 62b is arranged so as to oppose a region of the first main surface 41b of the second conductor 4b in which a dimension ratio of a length L23 from the outer peripheral surface 43b to a length L13 of the second line segment is equal to or less than one half. The length L13 of the second line segment is a length of a line segment connecting the center 44b (center of gravity) of the first main surface 41b and the outer peripheral surface 43b. Preferably, the second coil conductor portion 62b is arranged so as to oppose a region of the first main surface 41b of the second conductor 4b in which a dimension ratio of the length L23 from the outer peripheral surface 43b to the length L13 of the second line segment is equal to or less than one quarter.

By the plurality of coil conductors 6b being provided as in the third embodiment, the Q value of the antenna device 1b can be increased. The Q value of the antenna device 1b is proportional to an inductance of an inductor component of the coil conductor 6b, and inversely proportional to a resistance value of a resistance component of the coil conductor 6b. In the case of the plurality of coil conductors 6b, in comparison with a case of one coil conductor, an increase in the inductance of the inductor component is larger than an increase in the resistance value of the resistance component. Accordingly, the Q value of the antenna device 1b can be increased in the case of the plurality of coil conductors 6b, in comparison with the case of the one coil conductor.

(2) Operation of Antenna Device

Next, an operation of the antenna device 1b according to the third embodiment will be described with reference to FIG. 9 and FIG. 10B.

A current I3 corresponding to a transmission signal flows in the plurality of coil conductors 6b of the antenna coil 2b. Magnetic fluxes φ31 and φ32 are generated in the periphery of each of the coil conductors 6b by the current I3. More specifically, the magnetic flux φ31 is generated in the periphery of the first coil conductor portion 61b, and the magnetic flux φ32 is generated in the periphery of the second coil conductor portion 62b.

When the magnetic flux φ31 is generated by the current I3, an induced current I41 flows in the first conductor 3b so as to cancel a change in the magnetic flux φ31, and an induced current I51 flows in the third conductor 3c so as to cancel a change in the magnetic flux φ31. When the magnetic fluxes φ32 is generated by the current I3, an induced current I42 flows in the second conductor 4b so as to cancel a change in the magnetic flux φ32, and an induced current I52 flows in the fourth conductor 4c so as to cancel a change in the magnetic flux φ32. More specifically, by the magnetic flux φ31 based on the current I3 flowing in the first coil conductor portion 61b, the induced current I41 flows along the edge end of the first conductor 3b and the induced current I51 flows along the edge end of the third conductor 3c. Furthermore, by the magnetic flux φ32 based on the current I3 flowing in the second coil conductor portion 62b, the induced current I42 flows along the edge end of the second conductor 4b and the induced current I52 flows in the fourth conductor 4c. By the induced current I41 of the first conductor 3b and the induced current I51 of the third conductor 3c, the magnetic flux φ41 is generated, and by the induced current I42 of the second conductor 4b and the induced current I52 of the fourth conductor 4c, the magnetic flux φ42 is generated.

In the antenna device 1b, the magnetic flux φ3 generated by the current I3 of the plurality of coil conductors 6b, the magnetic flux φ41 generated by the induced current I41 flowing in the first conductor 3b and the induced current I51 flowing in the third conductor 3c, and the magnetic flux φ42 generated by the induced current I42 flowing in the second conductor 4b and the induced current I52 flowing in the fourth conductor 4c are oriented in the same direction in the vicinity of the magnetic body 7b. With the configuration described above, the magnetic flux emitted from the antenna device 1b can be increased, and antenna characteristics of the antenna device 1b can be improved. As a result, when the electronic apparatus 8 and the external apparatus 9 communicate with each other, desired communication characteristics can be secured. In other words, by bringing the first conductor 3b and the second conductor 4b close to the antenna coil 2b from both sides of the antenna coil 2b, respectively, the induced currents I41 and I42 flow in the first conductor 3b and the second conductor 4b, respectively, such that the magnetic fluxes φ41 and φ42 are generated in the same direction as that of the magnetic flux φ3 emitted from the antenna coil 2b in the second direction D2. This makes it possible to improve the communication characteristics in the second direction D2.

Furthermore, sandwiching the antenna coil 2b between the first conductor 3b and the third conductor 3c and the second conductor 4b and the fourth conductor 4c makes it possible to change the directivity of the magnetic flux. That is, the direction in which the magnetic flux is largely emitted can be changed from the first direction D1 to the second direction D2. With this, when the electronic apparatus 8 and the external apparatus 9 communicate with each other, the electronic apparatus 8 and the external apparatus 9 are brought close to each other in the second direction D2, it is thus possible to reduce a possibility that the display unit 83 of the electronic apparatus 8 positioned in the first direction D1 with respect to the antenna device 1b makes contact with the external apparatus 9.

(3) Modifications

The antenna coil 2b is not limited to having a flat plate shape. Furthermore, the antenna coil 2b may be bent. For example, the magnetic body 7b is not limited to having a flat plate shape. The first main surface 71b of the magnetic body 7b is not limited to the flat surface, and may have at least one of a bent portion and a curved portion. In the same manner, the second main surface 72b of the magnetic body 7b is not limited to the flat surface, and may have at least one of a bent portion and a curved portion.

(4) Effects

As described above, in the antenna device 1b according to the third embodiment, the plurality of coil conductors 6b is provided. With this configuration, the Q value of the antenna device 1b can be increased, and thus the antenna characteristics can be further improved.

### SUMMARY

The following aspects are disclosed from the embodiments described above.

An antenna device (1; 1a; 1b) according to a first aspect includes an antenna coil (2; 2b), a first conductor (3; 3a; 3b), and a second conductor (4; 4a; 4b). The antenna coil (2; 2b) includes a magnetic body (7; 7a; 7b) having a first main surface (71; 71a; 71b) and a second main surface (72; 72a; 72b) and at least one coil conductor (6; 6b) having a spiral shape. The first conductor (3; 3a; 3b) is arranged opposing the first main surface (71; 71a; 71b) of the magnetic body (7; 7a; 7b). The second conductor (4; 4a; 4b) is arranged opposing the second main surface (72; 72a; 72b) of the magnetic body (7; 7a; 7b). When viewed from a direction along the first main surface (71; 71a; 71b) or the second main surface (72; 72a; 72b) of the magnetic body (7; 7a; 7b), the antenna coil (2; 2b) is positioned between the first conductor (3; 3a; 3b) and the second conductor (4; 4a; 4b). The coil conductor (6; 6b) includes a first coil conductor portion (61; 61b) and a second coil conductor portion (62; 62b). The first coil conductor portion (61; 61b) is closer to the first main surface (71; 71a; 71b) than to the second main surface (72; 72a; 72b) of the magnetic body (7; 7a; 7b). The second coil conductor portion (62; 62b) is closer to the second main surface (72; 72a; 72b) than to the first main surface (71; 71a; 71b) of the magnetic body (7; 7a; 7b). The first coil conductor portion (61; 61b) and the second coil conductor portion (62; 62b) are positioned at positions not overlapping with each other in a plan view of the magnetic body (7; 7a; 7b). The second coil conductor portion (62; 62b) overlaps with the second conductor (4; 4a; 4b) in a plan view of the magnetic body (7; 7a; 7b), and at least a part of the second coil conductor portion (62; 62b) is arranged along an edge end of the second conductor (4; 4a; 4b) in a plan view of the magnetic body (7; 7a; 7b).

In the antenna device (1; 1a; 1b) according to the first aspect, the second coil conductor portion (62; 62b) overlaps with the second conductor (4; 4a; 4b) in a plan view of the magnetic body (7; 7a; 7b), and at least a part of the second coil conductor portion (62; 62b) is arranged along the edge end of the second conductor (4; 4a; 4b). With this configuration, unlike the case where the first conductor and the second conductor each have a slit, the first conductor (3; 3a; 3b) and the second conductor (4; 4a; 4b) do not deteriorate in strength. That is, the strength of the antenna device (1; 1a; 1b) is not reduced. Additionally, since induced currents (121, 122; 141, 142) generated in the first conductor (3; 3a; 3b) and the second conductor (4; 4a; 4b) can generate magnetic fluxes (φ21, φ22; φ41, φ42), respectively, in a direction (second direction D2) orthogonal to a winding axis of the coil conductor (6; 6b), the magnetic flux in the above-described direction (second direction D2) from the antenna device (1; 1a; 1b) can be increased. As a result, the antenna characteristics can be improved.

In the antenna device (1; 1a) according to a second aspect, in the first aspect, the first coil conductor portion (61) overlaps with the first conductor (3; 3a) in a plan view of the magnetic body (7; 7a), and at least a part of the first coil conductor portion (61; 61a) is arranged along an edge end of the first conductor (3; 3a) in a plan view of the magnetic body (7; 7a; 7b).

In the antenna device (1; 1a) according to a third aspect, in the second aspect, entirety of the first coil conductor portion (61) is arranged along the edge end of the first conductor (3; 3a).

In the antenna device (1; 1a) according to the third aspect, the entirety of the first coil conductor portion (61) is arranged along the edge end of the first conductor (3; 3a). With this configuration, since portions of the first coil conductor portion (61) close to the edge end of the first conductor (3; 3a) are increased, the induced current (121) can be made easy to be generated in the first conductor (3; 3a).

In the antenna device (1; 1a; 1b) according to a fourth aspect, in any one of the first to third aspects, entirety of the second coil conductor portion (62; 62b) is arranged along the edge end of the second conductor (4; 4a; 4b).

In the antenna device (1; 1a; 1b) according to the fourth aspect, the entirety of the second coil conductor portion (62; 62b) is arranged along the edge end of the second conductor (4; 4a; 4b). With this configuration, since portions of the second coil conductor portion (62; 62b) close to the edge end of the second conductor (4; 4a; 4b) are increased, the induced current (122; 142) can be made easy to be generated in the second conductor (4; 4a; 4b).

In the antenna device (1b) according to a fifth aspect, in any one of the first to fourth aspects, a plurality of the coil conductors (6b) is provided.

In the antenna device (1b) according to the fifth aspect, the plurality of coil conductors (6b) is provided. With this configuration, the Q value of the antenna device (1b) can be increased, and thus the antenna characteristics can be further improved.

In the antenna device (1b) according to a sixth aspect, in any one of the first to fifth aspects, an outer edge of the magnetic body (7b) is positioned in an outer side portion relative to an outer edge of the coil conductor (6b) in one direction (second direction D2).

The antenna device (1b) according to a seventh aspect, in any one of the first to sixth aspects, further includes a third conductor (3c) and a fourth conductor (4c). The third conductor (3c) is positioned on an opposite side from the coil conductor (6b) with respect to the first conductor (3b), and is formed of a material different from a material of the first conductor (3b). The fourth conductor (4c) is positioned on an opposite side from the coil conductor (6b) with respect to the second conductor (4b), and is formed of a material different from a material of the second conductor (4b).

An antenna coil (2; 2b) according to an eighth aspect includes a magnetic body (7; 7a; 7b) and at least one coil conductor (6; 6b). The magnetic body (7; 7a; 7b) has a first main surface (71; 71a; 71b) and a second main surface (72; 72a; 72b). The coil conductor (6; 6b) has a spiral shape. The magnetic body (7; 7a; 7b) and the coil conductor (6; 6b) are, when viewed from a direction along the first main surface (71; 71a; 71b) or the second main surface (72; 72a; 72b) of the magnetic body (7; 7a; 7b), positioned between a first conductor (3; 3a; 3b) and a second conductor (4; 4a; 4b). The coil conductor (6; 6b) includes a first coil conductor portion (61; 61b) and a second coil conductor portion (62; 62b). The first coil conductor portion (61; 61b) is closer to the first main surface (71; 71a; 71b) than to the second main surface (72; 72a; 72b) of the magnetic body (7; 7a; 7b). The second coil conductor portion (62; 62b) is closer to the second main surface (72; 72a; 72b) than to the first main surface (71; 71a; 71b) of the magnetic body (7; 7a; 7b). The first coil conductor portion (61; 61b) and the second coil conductor portion (62; 62b) are positioned at positions not overlapping with each other in a plan view of the magnetic body (7; 7a; 7b). The second coil conductor portion (62; 62b) overlaps with the second conductor (4; 4a; 4b) in a plan view of the magnetic body (7; 7a; 7b), and at least a part of the second coil conductor portion (62; 62b) is arranged along an edge end of the second conductor (4; 4a; 4b) in a plan view of the magnetic body (7; 7a; 7b).

In the antenna coil (2; 2b) according to the eighth aspect, the second coil conductor portion (62; 62b) overlaps with the second conductor (4; 4a; 4b) in a plan view of the magnetic body (7; 7a; 7b), and at least a part of the second coil conductor portion (62; 62b) is arranged along the edge end of the second conductor (4; 4a; 4b). With this configuration, unlike the case where the first conductor and the second conductor each have a slit, the first conductor (3; 3a; 3b) and the second conductor (4; 4a; 4b) do not deteriorate in strength. That is, the strength of the antenna device (1; 1a; 1b) is not reduced. Additionally, since induced currents (121, 122; 141, 142, 151, 152) generated in the first conductor (3; 3a; 3b) and the second conductor (4; 4a; 4b) can generate magnetic fluxes (φ21, φ22; φ41, φ42), respectively, in a direction (second direction D2) orthogonal to a winding axis of the coil conductor (6; 6b), the magnetic flux in the above-described direction (second direction D2) from the antenna device (1; 1a; 1b) can be increased. As a result, the antenna characteristics can be improved.

In the antenna coil (2b) according to a ninth aspect, in the eighth aspect, the first coil conductor portion (61b) overlaps with the first conductor (3b) in a plan view of the magnetic body (7b), and at least a part of the first coil conductor portion (61b) is arranged along an edge end of the first conductor (3b) in a plan view of the magnetic body (7b).

In the antenna coil (2b) according to a tenth aspect, in the eighth or ninth aspect, a plurality of the coil conductors (6b) is provided.

In the antenna coil (2b) according to the tenth aspect, the plurality of coil conductors (6b) is provided. With this configuration, the Q value of the antenna device (1b) can be increased, and thus the antenna characteristics can be further improved.

In the antenna coil (2b) according to an eleventh aspect, in any one of the eighth to tenth aspects, an outer edge of the magnetic body (7b) is positioned in an outer side portion relative to an outer edge of the coil conductor (6b) in one direction (second direction D2).

An electronic apparatus (8) according to a twelfth aspect includes the antenna device (1; 1a; 1b) according to any one of the first to seventh aspects and a signal processing circuit (81). The signal processing circuit (81) performs signal processing on a signal of the antenna device (1; 1a; 1b).

In the electronic apparatus (8) according to the twelfth aspect, the second coil conductor portion (62; 62b) overlaps with the second conductor (4; 4a; 4b) in a plan view of the magnetic body (7; 7a; 7b), and at least a part of the second coil conductor portion (62; 62b) is arranged along the edge end of the second conductor (4; 4a; 4b). With this configuration, unlike the case where the first conductor and the second conductor each have a slit, the first conductor (3; 3a; 3b) and the second conductor (4; 4a; 4b) do not deteriorate in strength. That is, the strength of the antenna device (1; 1a; 1b) is not reduced. Additionally, since induced currents (121, 122; 141, 142) generated in the first conductor (3; 3a; 3b) and the second conductor (4; 4a; 4b) can generate magnetic fluxes (φ21, φ22; φ41, φ42), respectively, in a direction (second direction D2) orthogonal to a winding axis of the coil conductor (6; 6b), the magnetic flux in the above-described direction (second direction D2) from the antenna device (1; 1a; 1b) can be increased. As a result, the antenna characteristics can be improved.

The electronic apparatus (8) according to a thirteenth aspect, in the twelfth aspect, further includes a display unit (83). The display unit (83) is provided on an opposite side from the antenna coil (2; 2b) with respect to the first conductor (3; 3a; 3b).

In the electronic apparatus (8) according to the thirteenth aspect, the display unit (83) is provided on the opposite side from the antenna coil (2; 2b) with respect to the first conductor (3; 3a; 3b). Even when the display unit (83) as described above is provided, while reducing contact of the display unit (83) with an external apparatus (9) which is a communication target of the electronic apparatus (8), the communication between the electronic apparatus (8) and the external apparatus (9) can be performed.

The embodiments described above are only part of the various embodiments of the present disclosure. In addition, as long as the object of the present disclosure can be achieved, the embodiments can be variously modified in accordance with design or the like.

What is claimed is:

1. An antenna device comprising:
an antenna coil including a magnetic body having a first main surface and a second main surface and at least two coil conductors each having a spiral shape;
a first conductor arranged opposing the first main surface of the magnetic body; and
a second conductor arranged opposing the second main surface of the magnetic body,
wherein
the antenna coil is, when viewed from a direction along the first main surface or the second main surface of the magnetic body, positioned between the first conductor and the second conductor,
each of the two coil conductors includes
a first coil conductor portion closer to the first main surface than to the second main surface of the magnetic body, and
a second coil conductor portion closer to the second main surface than to the first main surface of the magnetic body,
in each of the two coil conductors, the first coil conductor portion and the second coil conductor portion are positioned at positions not overlapping with each other in a plan view of the magnetic body,
the two coil conductors are provided side by side in a plan view of the magnetic body,
the first coil conductor portions of the two coil conductors are closer to each other, in a side-by-side direction of the two coil conductors, than the second coil conductor portions of the two coil conductors,
directions of currents flowing in the two coil conductors are opposite from each other in a plan view of the magnetic body, and
in each of the two coil conductors, the second coil conductor portion overlaps with the second conductor in a plan view of the magnetic body, and at least a part of the second coil conductor portion is arranged along an edge end of the second conductor in a plan view of the magnetic body.

2. An antenna device comprising:
an antenna coil including a magnetic body having a first main surface and a second main surface and at least one coil conductor having a spiral shape;
a first conductor arranged opposing the first main surface of the magnetic body;
a second conductor arranged opposing the second main surface of the magnetic body; and
at least one of a third conductor positioned on an opposite side from the coil conductor with respect to the first conductor and formed of a material different from a material of the first conductor and a fourth conductor positioned on an opposite side from the coil conductor with respect to the second conductor and formed of a material different from a material of the second conductor,
wherein
the antenna coil is, when viewed from a direction along the first main surface or the second main surface of the magnetic body, positioned between the first conductor and the second conductor,
the coil conductor includes
a first coil conductor portion closer to the first main surface than to the second main surface of the magnetic body, and
a second coil conductor portion closer to the second main surface than to the first main surface of the magnetic body,
the first coil conductor portion and the second coil conductor portion are positioned at positions not overlapping with each other in a plan view of the magnetic body, and
the second coil conductor portion overlaps with the second conductor in a plan view of the magnetic body, and at least a part of the second coil conductor portion is arranged along an edge end of the second conductor in a plan view of the magnetic body.

3. The antenna device according to claim 1, further comprising:
a third conductor positioned on an opposite side from the two coil conductors with respect to the first conductor and formed of a material different from a material of the first conductor; and
a fourth conductor positioned on an opposite side from the two coil conductors with respect to the second conductor and formed of a material different from a material of the second conductor.

4. The antenna device according to claim 2, comprising:
both the third conductor and the fourth conductor.

5. The antenna device according to claim 1, wherein
the first coil conductor portion overlaps with the first conductor in a plan view of the magnetic body, and at least a part of the first coil conductor portion is arranged along an edge end of the first conductor in a plan view of the magnetic body.

6. The antenna device according to claim 5, wherein
entirety of the first coil conductor portion is arranged along the edge end of the first conductor.

7. The antenna device according to claim 1, wherein
entirety of the second coil conductor portion is arranged along the edge end of the second conductor.

8. The antenna device according to claim 2, wherein
the antenna coil includes a plurality of the coil conductors.

9. The antenna device according to claim 1, wherein
an outer edge of the magnetic body is positioned in an outer side portion relative to outer edges of all the coil conductors in one direction.

10. An antenna coil comprising:
a magnetic body having a first main surface and a second main surface; and
at least two coil conductors having a spiral shape,
wherein
the magnetic body and the two coil conductors are, when viewed from a direction along the first main surface or the second main surface of the magnetic body, positioned between a first conductor and a second conductor,
each of the two coil conductors includes
a first coil conductor portion closer to the first main surface than to the second main surface of the magnetic body, and
a second coil conductor portion closer to the second main surface than to the first main surface of the magnetic body,
in each of the two coil conductors, the first coil conductor portion and the second coil conductor portion are positioned at positions not overlapping with each other in a plan view of the magnetic body,
the two coil conductors are provided side by side in a plan view of the magnetic body,
the first coil conductor portions of the two coil conductors are closer to each other, in a side-by-side direction of the two coil conductors, than the second coil conductor portions of the two coil conductors,
directions of currents flowing in the two coil conductors are opposite from each other in a plan view of the magnetic body, and
in each of the two coil conductors, the second coil conductor portion overlaps with the second conductor in a plan view of the magnetic body, and at least a part of the second coil conductor portion is arranged along an edge end of the second conductor in a plan view of the magnetic body.

11. The antenna coil according to claim 10, wherein
the first coil conductor portion overlaps with the first conductor in a plan view of the magnetic body, and at least a part of the first coil conductor portion is arranged along an edge end of the first conductor in a plan view of the magnetic body.

12. The antenna coil according to claim 10, wherein
an outer edge of the magnetic body is positioned in an outer side portion relative to outer edges of the two coil conductors in one direction.

13. An electronic apparatus comprising:
the antenna device according to claim 1; and
a signal processing circuit configured to perform signal processing on a signal of the antenna device.

14. The electronic apparatus according to claim 13, further comprising:
a display unit provided on an opposite side from the antenna coil with respect to the first conductor.

15. The antenna device according to claim 2, wherein
the first coil conductor portion overlaps with the first conductor in a plan view of the magnetic body, and at least a part of the first coil conductor portion is arranged along an edge end of the first conductor in a plan view of the magnetic body.

16. The antenna device according to claim 2, wherein
entirety of the second coil conductor portion is arranged along the edge end of the second conductor.

17. The antenna device according to claim 2, wherein
an outer edge of the magnetic body is positioned in an outer side portion relative to outer edges of all the coil conductors in one direction.

18. The antenna coil according to claim 11, wherein
an outer edge of the magnetic body is positioned in an outer side portion relative to outer edges of the two coil conductors in one direction.

19. An electronic apparatus comprising:
the antenna device according to claim 2; and
a signal processing circuit configured to perform signal processing on a signal of the antenna device.

20. The electronic apparatus according to claim 19, further comprising:
a display unit provided on an opposite side from the antenna coil with respect to the first conductor.
